(19) United States
(12) Patent Application Publication
(10) Pub. No.: US 2024/0130451 A1
(43) Pub. Date: Apr. 25, 2024

(54) RESPIRATORY MASK

(71) Applicant: Wade Lamont Yoder, Fort Valley, GA (US)

(72) Inventor: Wade Lamont Yoder, Fort Valley, GA (US)

(21) Appl. No.: 18/403,251

(22) Filed: Jan. 3, 2024

Related U.S. Application Data
(63) Continuation-in-part of application No. 16/949,610, filed on Nov. 6, 2020.

(51) Int. Cl. A41D 13/11; A61M 16/06; A61M 16/10

(52) U.S. Cl. CPC A41D 13/1138; A41D 13/1161; A61M 16/0694; A61M 16/105; A61M 2202/0225

(57) ABSTRACT

A respiratory protective mask that prevents carbon dioxide rebreathing is disclosed. The respiratory mask includes a filter element that is dimensioned to cover an opening of a wearer's mouth. A cup like element is configured to rest against and retain the filter element against a wearer's chin. A top extent of the filter element extends laterally across a wearer's lip between a wearer's nose and the opening of the wearer's mouth, when worn. An arm of the filter element is defined by a convergence of the top extent and a lower extent of the filter element. The lower extent that converges upwardly from the cup like element towards a lateral end of the filter element subjacent to a wearer's ear, when worn. A retaining element is attached at the lateral end of the filter element and is configured to removably secure the filter element to cover the wearer's mouth.

### CROSS-REFERENCE TO RELATED APPLICATION

This application claims the benefit of priority of U.S. non-provisional application Ser. No. 16/949,610, filed 6 Nov. 2020, the contents of which are herein incorporated by reference.

### BACKGROUND OF THE INVENTION

The present invention relates to personal protective equipment, and more particularly to personal respiratory face masks.

Traditional personal protective masks are dimensioned to cover the user's nasal and oral cavities. Wearing these traditional respiratory protective masks may cause a user's blood carbon dioxide level to increase due to rebreathing of exhaled air. Studies indicate that mask wearing is primarily to prevent an infected carrier from infecting others due to exhaled droplets, rather than primarily protecting the wearer from airborne infection. Carbon dioxide from air that has already been breathed can be unhealthy, and forcing people to do this solely to enforce a mask policy can be deleterious to the wearer.

As can be seen, there is a need for an improved respiratory mask that assists users to breathe unrestricted through the nasal passages, while still protecting the public from the primary source of respiratory droplets (from the wearers mouth).

### SUMMARY OF THE INVENTION

In one aspect of the present invention, a respiratory mask is disclosed. The respiratory mask includes a filter element that is dimensioned to cover an opening of a wearer's mouth. A cup like element is configured to rest against and retain the filter element against a wearer's chin. A top extent of the filter element extends laterally across a wearer's lip between a wearer's nose and the opening of the wearer's mouth, when worn. An arm of the filter element is defined by a convergence of the top extent and a lower extent of the filter element. The lower extent that converges upwardly from the cup like element towards a lateral end of the filter element subjacent to a wearer's ear, when worn. A retaining element is attached at the lateral end of the filter element. The retaining element is configured to removably secure the filter element to cover the opening of the wearer's mouth.

In some embodiments, the filter element has a bilateral symmetry about a medial axis of the filter element.

The filter element may be made from a woven or a non-woven fabric.

In some embodiments, the retaining element includes an elastic band attached from the lateral end of the filter element. The elastic band may have an adjustment means for setting a desired tension of the filter element across the opening of the wearer's mouth. The adjustment means may include a buckle.

In other embodiments, the retaining element may be a first tie string attached to the end of the filter element. A second tie string attached along the top extent of the filter element and medially spaced apart from the end of the filter element. The first tie element and the second tie element are formed of an elastic band.

In yet other embodiments, the retaining element includes an ear loop. An upper end of the ear loop is attached to the top extent of the filter element and medially spaced apart from the end of the filter element. A lower end of the ear loop is attached to the end of the filter element.

In another embodiment, the present invention may include method of securing a filter element over a wearer's mouth but not their nose, the method including the following: forming a cup like element from the filter element, wherein the cup-like element is configured to rest against and retain the filter element against the wearer's chin, a top extent of the filter element extends laterally across a wearer's lip between the wearer's nose and the opening of the wearer's mouth; attaching a retaining element at each lateral end of the filter element, wherein the retaining element is configured to removably secure the filter element to cover the opening of the wearer's mouth without covering the wearer's nose; and connecting the filter element and the retaining element by way of a crossover tensioner.

In one embodiment the present invention may include a respiratory mask for limiting an incidence of carbon dioxide rebreathing, the respiratory mask providing: a filter element that is dimensioned to cover an opening of a wearer's mouth, a cup element configured to cup a wearer's chin, a top extent of the filter element extends laterally across a wearer's lip between a wearer's nose and the opening of the wearer's mouth, when worn, an arm of the filter element is defined by a convergence of the top extent and a lower extent of the filter element, the lower extent that extends upwardly from the cup element and converges at a lateral end of the filter element, wherein the lateral end is subjacent to both a wearer's ear and the wearer's nose when worn; and a retaining element attached to an attachment point at the lateral end of the filter element, wherein the attachment point is disposed below both the wearer's ear and the wearer's nose, when worn, so that securing the retaining element configured to removably secure the filter element to cover the opening of the wearer's mouth limits the incidence of carbon dioxide rebreathing through a conjunction of (a) the top extent of the filter element that extends laterally from the wearer's lip between the wearer's nose and the opening of wearer's mouth to the lateral end disposed below the wearer's nose and (b) the cup element cupping the wearer's chin.

In yet another embodiment the present invention may include a respiratory mask having the following: a filter element that is dimensioned to cover an opening of a wearer's mouth, a cup like element configured to rest against and retain the filter element against a wearer's chin, a top extent of the filter element extends laterally across a wearer's lip between the wearer's nose and the opening of the wearer's mouth, when worn; a retaining element attached at each lateral end of the filter element, wherein the retaining element is configured to removably secure the filter element to cover the opening of the wearer's mouth without covering the wearer's nose; and a crossover tensioner connecting the retaining element at each lateral end of the filter element, wherein each crossover tensioner comprises a crossover connection point, wherein each crossover tensioner is integrated with the filter element, wherein each crossover tensioner is disposed between the filter element and the retaining element, wherein each crossover tensioner comprises a series of three endless loops, wherein a middle endless loop is integrated into the filter element, wherein each crossover tensioner comprises a series of three endless loops, wherein the two remaining loops are beyond the filter element.

The filter element may be made from a woven or a non-woven fabric These and other features, aspects and advantages of the present invention will become better understood with reference to the following drawings, description and claims.

### BRIEF DESCRIPTION OF THE DRAWINGS

FIG. 1: Shows a bandanna style iteration of the respiratory mask in-use.

FIG. 2: Shows a string style iteration of the respiratory mask in-use.

FIG. 3: Shows an ear loop style iteration of the respiratory mask in-use.

FIG. 4 is a side elevation view of the bandanna style configuration of the respiratory mask in-use, illustrating the cross-bracing tensioner 6 at the interconnection of the filter element 2 and the bandanna style or strap style retaining element 3.

FIG. 5 is a side elevation view of the string style configuration of the respiratory mask in-use, illustrating the crossover string tensioner 7 at the interconnection of the filter element 2 and the string style retaining element 4.

FIG. 6 is a side elevation view of the ear loop style configuration of the respiratory mask in-use, illustrating the continuous crossover loop tensioner 8, which is also shown in FIG. 12, whereby the continuous crossover loop tensioner 8 provides three consecutive loops, respectively connected to each other by a crossover connection point 30, wherein the middle loop is integrated in the filter element 2.

FIG. 7 is a side elevation view of the strap configuration of the respiratory mask in-use, illustrating the boxed cross-bracing tensioner 16 at the interconnection of the filter element 2 and the bandanna style retaining element 3. The boxed cross-bracing tensioner 16 may provide a frame element 166 to increase the tension of the tensioner 16.

FIG. 8 is a side elevation view of the string style configuration of the respiratory mask in-use, illustrating the isolated crossover string tensioner 17 providing upper and lower connections points 171 and 172 operatively associated with upper and lower connection points 21, 22 of the filter element 2. Filter element 2 may have a wedge 25 cutout along its lateral edge to facilitate the isolation of the upper and lower connection points 171 and 172 with the spaced apart upper and lower filter element connection points 21 and 22.

FIG. 9 is a side elevation view of the ear loop configuration of the respiratory mask in-use, illustrating the crossover continuous loop tensioner 8 or, alternatively an isolated crossover loop tensioner 18 providing upper and lower connections points 181 and 182 operatively associated with upper and lower connection points 21, 22 of the filter element 2.

FIG. 10 is a side elevation view of the bandanna/strap style configuration of the respiratory mask in-use, illustrating two spaced apart tensioners 19 operatively associated with upper and lower connection points 21, 22 of the filter element 2, so as to interconnect the latter with the strap retaining element 3.

FIG. 11 is a side elevation view of the bandanna/strap style configuration of the respiratory mask in-use, illustrating the isolated cross-bracing tensioner 16 disposed between of the filter element 2 and the bandanna style retaining element 3.

FIG. 12 is a front elevation view of an exemplary embodiment of the continuous crossover loop tensioner 8 of the present invention.

FIG. 13A and FIG. 13B are front elevation views of isolated loop tensioners 18 illustrating their upper and lower connections points 181, 182 inward of their respective crossover connection points 30.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides an improved respiratory mask that limits the incidence of carbon dioxide rebreathing by the wearer. The present invention provides a mouth only mask that leaves the nose exposed and free to breathe new air. The mouth covering catches respiratory droplets from the primary source of respiratory droplet transmission, the mouth.

The present invention facilitates the ears, neck and nose of the wearer assisting in stabilization and helping secure a face mask/filter element 2 in position. For the purpose of a filter element 2 that is designed to only cover the mouth it needs something different to keep the mask from riding up or down on the wearer's face and to keep it secured. The portion of the mask that supplies appropriate tension (elastic or other forms of stretchy material and referred to hereafter as tensioners), and the way they are attached (connected or interconnected between the filter element 2 and its retaining element) are critical as they will give the mouth mask a more secure position on the wearer's face.

The way the mouth mask will be held in a more secured fashion is by a tensioner that feeds into or attaches to the filter element 2, wherein the tensioner provides crossover component—almost like an X—i.e., crossover connection point 30.

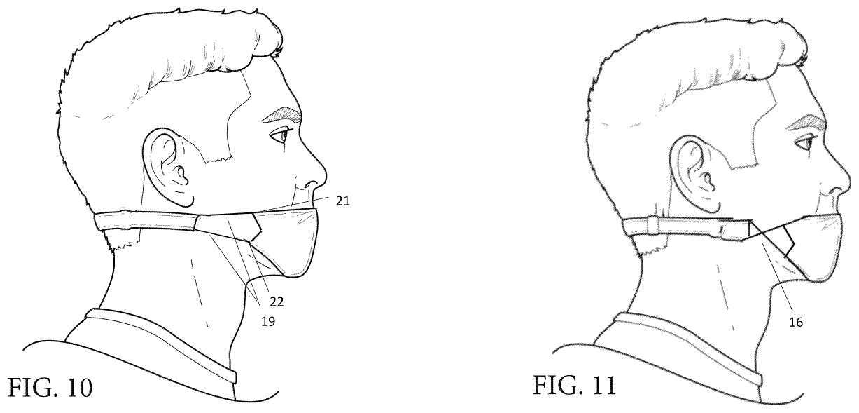

In the string retaining element 4 style, see FIGS. 5 and 8, the upper string connects to or into the lower portion of the mask after the crossover connection point 30, and the lower string connects to or into the upper portion of the mask through a similar transition via the crossover connection point 30. The disposition of the crossover connection point 30 enable functional symmetry of mouth, chin, and ear (with each other), thereby providing the tension needed to secure the mask under the chin and between the nose and the upper lip. The upper part of the ear aligns with the jawline to secure the lower portion that fits around and under the chin, and the bottom of the ears line up with the wearer's lip to secure the upper portion of the mask. Designs include ones that tie in the back of the head and neck, see FIGS. 5 and 8, wherein an upper connection point 71/171 (that attaches to an upper attachment point 21 of the filter element 2) of a crossover string tensioner 7/17 is associated with a lower strong element tied in the back of the head and neck. And vice versa with the lower connection point 72/172 of the crossover string tensioner 7/17 attaching to the lower portion/attachment point 22 of the filter element 2 while being associated with upper portion of the string retaining element 4 behind the wearer's head.

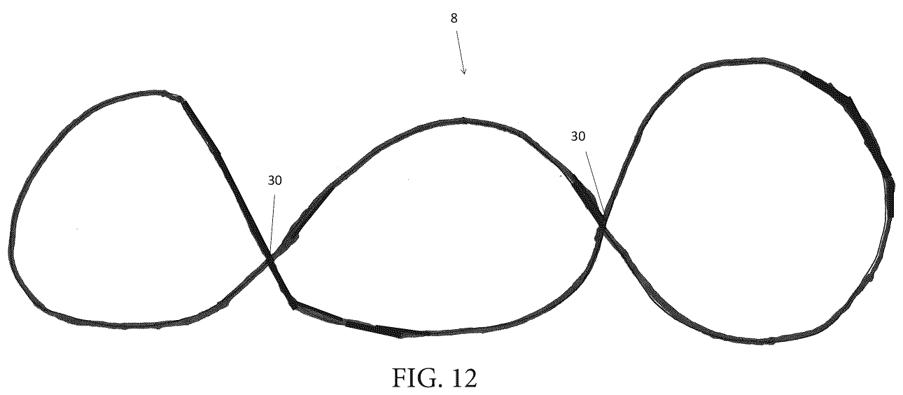

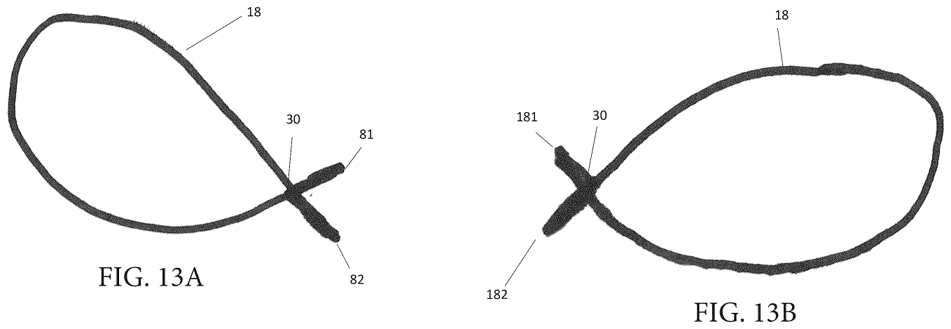

The continuous crossover tensioner 8 may be a continuous loop through the filter element 2 from left to right side much like two figure eights joined together into a continuous loop—as illustrated in FIG. 12—resulting in three consecutive loops. The middle loop of the three consecutive loops may be integrated into or attached to the filter element 2 at varying distances to the halfway point inside the filter element 2. The crossover connection point 30 of upper and lower tensioners can be at a point inside or outside of the mask, see FIGS. 6 and 9.

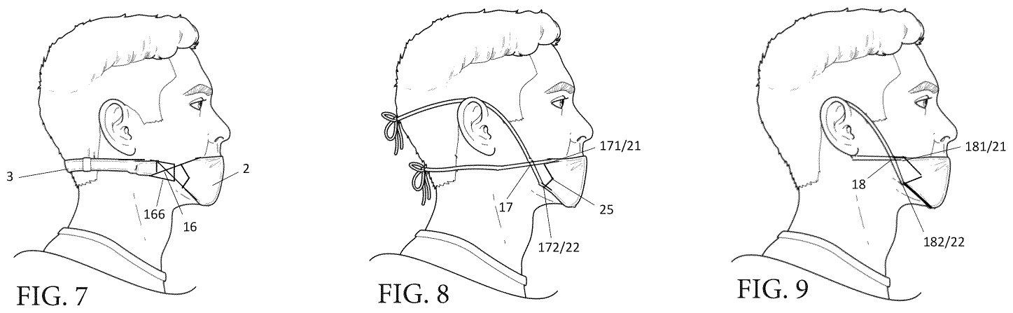

Referring to FIGS. 4, 7 and 10 masks designed with a neck strap (and do not utilize the ears for anchoring purposes), will have two tensioner attachments 16 to interconnect the filter element 2 to the neck strap 3. This will increase comfort for the wearer and increase the range of face sizes the mask will fit while helping keep it in position to cover the area just below the nose and under the wearer's chin. These tensioner attachments 6/16 will decrease or negate the need for the wearer to adjust the neck strap in comparison to it being fastened directly to the mask. The tensioner portion 6/16 can function with its attachment on the inside or outside of the neck strap (FIG. 4 has the cross-bracing tensioner 6 integrated with the strap-to-mask-direct connection, while FIG. 7 has the cross-bracing tensioner 16 disposed between the strap 3 and the filter element 2). The two tensioner attachments may be crossed or, alternatively, designed uncrossed—providing two horizontal attachment tensioners 19 (see FIG. 10) to join the filter element 2 with the neck strap 3.

The purpose of this addendum to the design of the mouth mask is to enhance its functional fit to a wearer's face, and to move with it instead of against it.

Other available respiratory masks are constructed as if the air is bad around the user. However, the mouth only mask according to the present invention will catch respiratory droplets exhaled through the wearer's mouth, while still allowing the user to have the option to breathe clean fresh air through their nasal passages rather than rebreathed, high carbon dioxide are, resulting in a lower carbon dioxide intake by the wearer. The mask of the present invention helps users breathe unrestricted through the nasal passages, while still protecting the public from the primary source of respiratory droplets (from the wearers mouth).

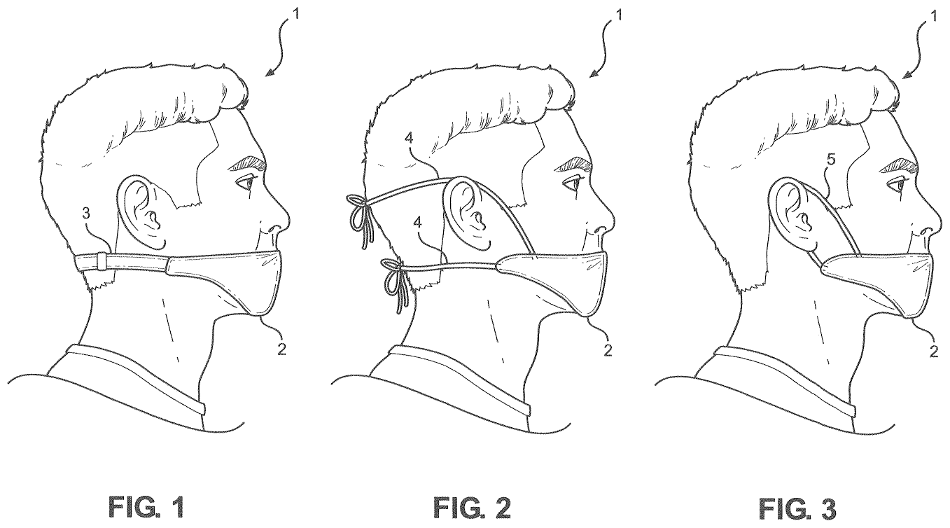

As seen in reference to the drawings of FIGS. 1-3, the respiratory mask 1 of the present invention includes a filter element 2 that is dimensioned to cover the oral opening of the mouth and has a cup like element to rest against and retain the filter element 2 against the wearer's chin. A top extent of the filter element 2 extends laterally across the wearer's lip between the wearer's nose and the opening of the mouth. An arm of the filter element 2 extends laterally with a lower extent of the filter element 2 extending upwardly from the cup like element and converging towards a lateral end of the filter element 2, and subjacent to the wearer's ear. The filter element 2 of the respiratory mask 1 has a bilateral symmetry about a medial axis of the filter element 2.

As seen in reference to FIG. 1, the filter element 2 is secured to the wearer's head by an elastic band 3 extending from the lateral end of the filter element 2. The elastic band 3 may have a buckle or adjustment means for setting a desired tension of the filter element across the wearer's mouth.

In first alternative embodiment, shown in reference to FIG. 2, a first and second tie strings 4 are attached to the end of the filter element with a second tie element attached along the top extent of the filter element 2 and medially spaced apart from the end of the filter element 2. The first tie element and the second tie element may be formed of a string or an elastic band to adjust tension of the filter element 2 to the wearer's mouth.

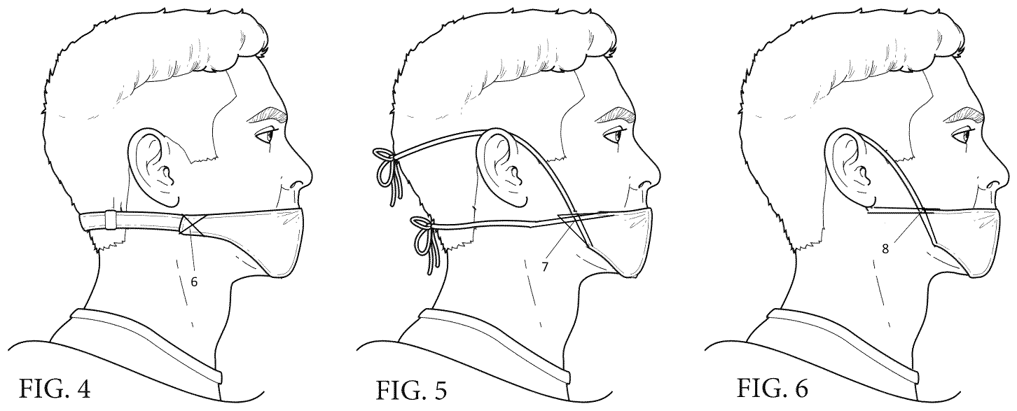

A second alternative embodiment is shown in reference to FIG. 3. In this embodiment an ear loop 5 is provided. An upper end of the ear loop is attached to the top extend of the filter element 2 and medially spaced apart from the end of the filter element 2. A lower end of the ear loop 5 is attached to the end of the filter element 2.

Securement of the retaining elements 3, 4, and 5 at the end of the filter element 2 ensures that the filter element 2 is drawn laterally across the wearer's mask. Securement of the retaining elements 4 and 5 along the top extent of the filter element 2 and medially spaced apart from the end of the filter element 2 assists with preventing the filter element 2 from drooping on the wearer's face.

The filter element 2 may be formed of a suitable filtration medium indicated by a prevailing pathogen. The filter element 2 may be formed of either a woven or non-woven material. The filter element may include a stitch, binding, or a bias around the peripheral extents of the filter element 2.

The mask part that covers the mouth and chin is held in position by loops that go around the ear or fasten with a neck strap that wraps around the back of head and or neck

The filter element may be sewn from a fabric designed to fit comfortably around the mouth and chin. The cup element needs to come far enough under the chin to cup the filter element 2 in position to catch respiratory droplets emitted as the wearer exhales through the mouth. The mask can be attached to the face by fasteners that either loop around ears or wrap around to the back of head and or neck.

Both the mouth/chin piece and the way it fastens are equally important. The wearer may have this on for long periods, so whether it is secured by loops that go around the ear or strap all the way around the back of the head, comfort is of utmost importance. The profile and fit of the filter element 2 facilitates wearer comfort, to the point where the wearer may forget it is on his/her face.

The wearer would use it to cover their mouth while around others to protect others from the wearers respiratory droplets.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A respiratory mask, comprising:
a filter element that is dimensioned to cover an opening of a wearer's mouth, a cup like element configured to rest against and retain the filter element against a wearer's chin, a top extent of the filter element extends laterally across a wearer's lip between the wearer's nose and the opening of the wearer's mouth, when worn;
a retaining element attached at each lateral end of the filter element, wherein the retaining element is configured to removably secure the filter element to cover the opening of the wearer's mouth without covering the wearer's nose; and
a crossover tensioner connecting the retaining element at each lateral end of the filter element.

2. The respiratory mask of claim 1, wherein the filter element has a bilateral symmetry about a medial axis of the filter element.

3. The respiratory mask of claim 2, the retaining element comprising:
an elastic band attached from the lateral end of the filter element.

4. The respiratory mask of claim 3, wherein the elastic band has an adjustment means for setting a desired tension of the filter element across the opening of the wearer's mouth.

5. The respiratory mask of claim 4, wherein the adjustment means comprises:
a buckle.

6. The respiratory mask of claim 2, wherein the retaining element comprises:
a first tie string attached to the lateral end of the filter element.

7. The respiratory mask of claim 6, further comprising:
a second tie element attached along the top extent of the filter element and medially spaced apart from the lateral end of the filter element.

8. The respiratory mask of claim 7, wherein the first tie string and the second tie string are formed of an elastic band.

9. The respiratory mask of claim 2, wherein the retaining element comprises:
an ear loop, an upper end of the ear loop is attached to the top extent of the filter element and medially spaced apart from the lateral end of the filter element; and
a lower end of the ear loop is attached to the end of the filter element.

10. The respiratory mask of claim 1, wherein each crossover tensioner comprises a crossover connection point.

11. The respiratory mask of claim 1, wherein each crossover tensioner is integrated with the filter element.

12. The respiratory mask of claim 1, wherein each crossover tensioner is disposed between the filter element and the retaining element.

13. The respiratory mask of claim 1, wherein each crossover tensioner comprises a series of three endless loops, wherein a middle endless loop is integrated into the filter element.

14. The respiratory mask of claim 13, wherein each crossover tensioner comprises a series of three endless loops, wherein the two remaining loops are beyond the filter element.

15. A method of securing a filter element over a wearer's mouth but not their nose, the method comprising:
forming a cup like element from the filter element, wherein the cup-like element is configured to rest against and retain the filter element against the wearer's chin, a top extent of the filter element extends laterally across a wearer's lip between the wearer's nose and the opening of the wearer's mouth;
attaching a retaining element at each lateral end of the filter element, wherein the retaining element is configured to removably secure the filter element to cover the opening of the wearer's mouth without covering the wearer's nose; and
connecting the filter element and the retaining element by way of a crossover tensioner.
